(19) United States
(12) Patent Application Publication
(10) Pub. No.: US 2013/0269727 A1
(43) Pub. Date: Oct. 17, 2013

(54) Novel Solvents and Method of Cleaning Rubber from Runways

(71) Applicant: Michael G. Kinnaird, Durham, NC (US)

(72) Inventor: Michael G. Kinnaird, Durham, NC (US)

(73) Assignee: CHEMTEK, INC., Yanceyville, NC (US)

(21) Appl. No.: 13/446,109

(22) Filed: Apr. 13, 2012

(51) Int. Cl. B08B 1/00; B08B 3/08; B08B 3/02; C11D 3/60

(52) U.S. Cl. 134/6; 510/240

(57) ABSTRACT

This invention relates to a method of cleaning rubber off of rubber-soiled runways that utilizes solvents that are at least partially bio-derived. It is surprisingly found that cleaning compositions that utilize novel solvents that are at least partially bio-derived are effective runway cleaners, while simultaneously providing an enhanced environmental and/or economic profile to the formulation.

### CROSS REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC OR APPENDIX

Not Applicable

### BACKGROUND OF THE INVENTION

1. Field of the Invention

This invention relates to a composition and method of cleaning rubber off of runways that utilizes solvents that are at least partially biologically-derived, and thus are not subject to pricing and availiability issues plaguing petrochemical solvents. In addition, the solvents have the advantage of being biodegradable due to the fact that they are at least partially derived from biogenic sources. Toxicity to aquatic life is also greatly reduced.

2. Prior Art

It is well-known that when airplanes land on runways that at the moment of impact a differential in relative speed between the airplane's wheels and the runway causes some of the rubber to be transferred to the runway, making basically a skid mark on the runway surface. After enough landings, the number of skid marks gets so high that the frictional characteristics of the runway are reduced. When this happens, and the runway is wet, there is a very real danger of airplanes being unable to stop during landing, and crashing off the end of the runway, with loss of life, injury and damage to the airplane.

In the industry, there are two standard approaches to preventing this type of catastrophe. The first is high-pressure blasting utilizing ambient-temperature or high-temperature water, and the second is chemical solution cleaning, usually involving scrubbing with steel and/or nylon brushes followed by rinsing while scrubbing, but sometimes involving rinsing with pressurized water.

Typical water blasting operations use pressures ranging from 8,000 to 32,000 p.s.i. They literally blast away the build-up. Frequently, the pressure required to remove the rubber is greater than the cohesive strength of the concrete or asphalt binder. Therefore, this method of cleaning can cause damage to the pavement microtexture resulting in shortened runway life as well as reduced breaking action.

Therefore, in many situations, chemical cleaning is the preferred solution. As a non-destructive method of cleaning, alkaline chemical rubber removers have been increasingly used.

For a cleaning operation involving chemical cleaners, typically 100 to 600 gallons of runway cleaner is sprayed on the center 50 foot section of approximately 1,000-2,000 linear feet per runway end, for a rate of up to 0.055 gallons per square foot. This is enough to wet the runway, but not cause the cleaner to run off the runway.

The material is agitated for several hours with a runway broom or brooms. Then, the cleaner is rinsed to the edges using typically 50-100 gallons of rinse water per gallon of cleaner. Rinsing takes an additional one to three (1-3) hours, during which time the rinse water typically soaks into the grassy soil adjacent to the runway. Although the organic components of many runway cleaners will eventually biodegrade, some components are more easily handled by the environment than others.

Many cleaning compositions involve solvents, for example the terpene solvents d-limonene or dipentene, both natural-origin materials. Other solvents that have found utility are a class known as glycol ethers, exemplified by butoxyethanol (“EB”), or dipropylene glycol methyl ether (“DPM”).

The terpene solvents are effective at low levels, but their use involves utilizing materials known to be highly toxic to fish and other aquatic life, and their availability is quite variable, leading to shortages and large price swings.

The second class of solvents commonly utilized, the glycol ethers, have many advantages, such as effectiveness, but suffer from some disadvantages as well. For example, the ethylene-glycol-based glycol ethers suffer from serious toxicity concerns, and so are heavily scrutinized, e.g. by the EPA in their Toxics Release Inventory. Another problem of the glycol ethers is that they are petrochemicals, and with the increasing price of oil, their prices have increased substantially in recent years.

Thus, a cleaner without these powerful, effective, but increasingly expensive and unavailable and potentially toxic raw materials is desirable. However, it is not obvious that there are ready replacements for them. This is especially so if one desires to avoid utilizing petrochemicals. Since World War II, petroleum has by far been the major source for chemicals in the developed world.

It is the object of the instant invention to provide a method of chemically cleaning runways that involves replacement of either terpenes, glycol ethers or both.

### BRIEF DESCRIPTION OF THE INVENTION

It is an object of the instant invention to provide a composition and a method of cleaning rubber off of rubber-soiled runway surfaces which substitutes solvents that are partially or completely bio-derived for traditional runway cleaner solvents. This is surprisingly accomplished by utilizing the following composition and method. The cleaning composition comprises:
A. A nonionic surfactant containing at least one carbon chain of length 4-20 and at least one oxyethylene or oxypropylene group, said nonionic surfactant being from about 0.1 to about 10 percent by weight of the formulation as a whole,
B. At least one coupling agent selected from the group consisting of: a phosphate ester of a nonionic surfactant containing at least one carbon chain of length 4-20 and at least one oxyethylene or oxypropylene group, the molecular ratio of nonionic surfactant to phosphorous being from about 0.1 to about 2; alkylaromatic sulfonic acids and/or their salts, such as sodium xylene sulfonate; said coupling agent being from about 0.1 to about 10 percent by weight of the whole,
C. At least one solvent selected from the group containing benzyl alcohol, an acetal, which is a di(alkoxy) methane; alkyl esters of lactic acid, and optionally one solvent selected from the group consisting of glycol ether solvents and solvent terpenes, alkyl esters, terpene alcohols; said solvent or solvent combination being from about 0.1 to about 10 percent by weight of the whole,
D. At least one builder selected from the group containing hydroxides, silicates, phosphates, oligophosphates, polyphosphates, alkyl phosphonic acids, borates, carbonates or bicarbonates of sodium, potassium, lithium or cesium, said builder or builder combination being from about 0.1 to about 15 percent by weight (on an active ingredient basis) of the whole,
E. Optional additional surfactants selected from the group containing cationic, anionic, nonionic, amphoteric, amine oxide or diethanolamide surfactants, said optional surfactant or surfactant combination being from about 0.1 to about 10 percent by weight of the whole,
F. Optionally a hardness ameliorating agent selected from the group containing ethylenediamine tetra acetic acid, ethylenediamene triacetic acid, nitrilo-tris-acetic acid, glucuronic acid, gluconic acid, erythorbic acid, and citric acid and/or the sodium, potassium, lithium or cesium salts of these or mixtures and combinations of these, said hardness ameliorating agent being from about 0.1 to about 10 percent by weight of the whole, and
G. The balance being water.

The method of cleaning rubber off of rubber-soiled runways that does utilizes a cleaning composition with bio-derived solvents, comprising:
A. exposing a soiled runway surface to a cleaning composition by spraying, dumping or otherwise wetting the surface with the cleaner,
B. scrubbing for an efficacious amount of time using steel- and/or nylon-bristled brooms, followed by
C. rinsing using an appropriate amount of water while scrubbing, or alternatively after an efficacious amount of time of scrubbing, utilizing pressurized water to remove any detritus, or alternatively utilizing pressurized water to remove rubber and any detritus after exposing the runway to the cleaner without scrubbing, said cleaning composition comprising:
   1. A nonionic surfactant containing at least one carbon chain of length 4-20 and at least one oxyethylene or oxypropylene group, said nonionic surfactant being from about 0.1 to about 10 percent by weight of the formulation as a whole,
   2. At least one coupling agent selected from the group consisting of: a phosphate ester of a nonionic surfactant containing at least one carbon chain of length 4-20 and at least one oxyethylene or oxypropylene group, the molecular ratio of nonionic surfactant to phosphorous being from about 0.1 to about 2; alkylaromatic sulfonic acids and/or their salts, such as sodium xylene sulfonate; said coupling agent being from about 0.1 to about 10 percent by weight of the whole,
   3. At least one solvent selected from the group containing benzyl alcohol, an acetal which is a di(alkoxy) methane, alkyl esters of lactic acid, and optionally one solvent selected from the group consisting of glycol ether solvents and solvent terpenes, alkyl esters, terpene alcohols; said solvent or solvent combination being from about 0.1 to about 10 percent by weight of the whole,
   4. At least one builder selected from the group containing hydroxides, silicates, phosphates, oligophosphates, polyphosphates, alkyl phosphonic acids, borates, carbonates or bicarbonates of sodium, potassium, lithium or cesium, said builder or builder combination being from about 0.1 to about 15 percent by weight (on an active ingredient basis) of the whole,
   5. Optional additional surfactants selected from the group containing cationic, anionic, nonionic, amphoteric, amine oxide or diethanolamide surfactants, said optional surfactant or surfactant combination being from about 0.1 to about 10 percent by weight of the whole,
   6. Optionally a hardness ameliorating agent selected from the group containing ethylenediamine tetra acetic acid, ethylenediamene triacetic acid, nitrilo-tris-acetic acid, glucuronic acid, gluconic acid, erythorbic acid, and citric acid and/or the sodium, potassium, lithium or cesium salts of these or mixtures and combinations of these, said hardness ameliorating agent being from about 0.1 to about 10 percent by weight of the whole, and
   7. The balance being water.

### BRIEF DESCRIPTION OF THE SEVERAL VIEWS OF THE DRAWING

Not Applicable

### DETAILED DESCRIPTION OF THE INVENTION

It is an object of the instant invention to provide a composition for cleaning rubber off of runways. It is another object of the instant invention to provide a method of cleaning rubber off of rubber-soiled runway surfaces which employs solvents that are at least partially bio-derived. This is surprisingly accomplished by utilizing the following composition and method:

The cleaning composition comprises:
A. A nonionic surfactant containing at least one carbon chain of length 4-20 and at least one oxyethylene or oxypropylene group, said nonionic surfactant being from about 0.1 to about 10 percent by weight of the formulation as a whole,
B. At least one coupling agent selected from the group consisting of: a phosphate ester of a nonionic surfactant containing at least one carbon chain of length 4-20 and at least one oxyethylene or oxypropylene group, the molecular ratio of nonionic surfactant to phosphorous being from about 0.1 to about 2; alkylaromatic sulfonic acids and/or their salts, such as sodium xylene sulfonate; said coupling agent being from about 0.1 to about 10 percent by weight of the whole,
C. At least one solvent selected from the group containing benzyl alcohol, an acetal which is a di(alkoxy) methane, alkyl esters of lactic acid, and optionally one solvent selected from the group consisting of glycol ether solvents and solvent terpenes, alkyl esters, terpene alcohols; said solvent or solvent combination being from about 0.1 to about 10 percent by weight of the whole,
D. At least one builder selected from the group containing hydroxides, silicates, phosphates, oligophosphates, polyphosphates, alkyl phosphonic acids, borates, carbonates or bicarbonates of sodium, potassium, lithium or cesium, said builder or builder combination being from about 0.1 to about 15 percent by weight (on an active ingredient basis) of the whole,
E. Optional additional surfactants selected from the group containing cationic, anionic, nonionic, amphoteric, amine oxide or diethanolamide surfactants, said optional surfactant or surfactant combination being from about 0.1 to about 10 percent by weight of the whole,
F. Optionally a hardness ameliorating agent selected from the group containing ethylenediamine tetra acetic acid, ethylenediamene triacetic acid, nitrilo-tris-acetic acid, glucuronic acid, gluconic acid, erythorbic acid, and citric acid and/or the sodium, potassium, lithium or cesium salts of these or mixtures and combinations of these, said hardness ameliorating agent being from about 0.1 to about 10 percent by weight of the whole, and
G. The balance being water.

The method of cleaning rubber off of rubber-soiled runways that does utilizes a cleaning composition with bio-derived solvents, the method comprising:
A. exposing a soiled runway surface to a cleaning composition by spraying, dumping or otherwise wetting the surface with the cleaner,
B. scrubbing for an efficacious amount of time using steel- and/or nylon-bristled brooms, followed by
C. rinsing using an appropriate amount of water while scrubbing, or alternatively after an efficacious amount of time of scrubbing, utilizing pressurized water to remove any detritus, or alternatively utilizing pressurized water to remove rubber and any detritus after exposing the runway to the cleaner without scrubbing, said cleaning composition comprising:
   A. A nonionic surfactant containing at least one carbon chain of length 4-20 and at least one oxyethylene or oxypropylene group, said nonionic surfactant being from about 0.1 to about 10 percent by weight of the formulation as a whole,
   B. At least one coupling agent selected from the group consisting of: a phosphate ester of a nonionic surfactant containing at least one carbon chain of length 4-20 and at least one oxyethylene or oxypropylene group, the molecular ratio of nonionic surfactant to phosphorous being from about 0.1 to about 2; alkylaromatic sulfonic acids and/or their salts, such as sodium xylene sulfonate; said coupling agent being from about 0.1 to about 10 percent by weight of the whole,
   C. At least one solvent selected from the group containing benzyl alcohol, an acetal which is a di(alkoxy) methane, alkyl esters of lactic acid, and optionally one solvent selected from the group consisting of glycol ether solvents and solvent terpenes, alkyl esters, terpene alcohols; said solvent or solvent combination being from about 0.1 to about 10 percent by weight of the whole,
   D. At least one builder selected from the group containing hydroxides, silicates, phosphates, oligophosphates, polyphosphates, alkyl phosphonic acids, borates, carbonates or bicarbonates of sodium, potassium, lithium or cesium, said builder or builder combination being from about 0.1 to about 15 percent by weight (on an active ingredient basis) of the whole,
   E. Optional additional surfactants selected from the group containing cationic, anionic, nonionic, amphoteric, amine oxide or diethanolamide surfactants, said optional surfactant or surfactant combination being from about 0.1 to about 10 percent by weight of the whole,
   F. Optionally a hardness ameliorating agent selected from the group containing ethylenediamine tetra acetic acid, ethylenediamene triacetic acid, nitrilo-tris-acetic acid, glucuronic acid, gluconic acid, erythorbic acid, and citric acid and/or the sodium, potassium, lithium or cesium salts of these or mixtures and combinations of these, said hardness ameliorating agent being from about 0.1 to about 10 percent by weight of the whole, and
   G. The balance being water.

The instant invention of necessity involves wetting of the surface to be cleaned, penetration of the cleaning solution between the rubber and the substrate if possible, suspension of detached particles and emulsification of the solvent(s) added to aid in the removal process. These functions are preferably performed by surfactants. An essential surfactant class for these purposes is nonionic in nature, that is, does not have any electrical charges, positive or negative. This type of surfactant has an alkyl (aliphatic) or alkylaryl chain from about 6 to about 20 carbons, preferably from about 9 to about 18 carbons, and most preferably from about 12 to about 18 carbons. In a preferred embodiment, the alkyl chain portion of the nonionic surfactant consists of a mixture of alkyl chain lengths, and there is no aromatic component in the nonionic surfactant. In another preferred embodiment, the carbon chains are linear, with no branches in the chain, as these decrease biodegradability. In another preferred embodiment, the ethylene oxide (or in general alkylene oxide) portion of the nonionic surfactant comprises a range of ratios of alkylene oxide (“AO”) to active hydrogen compound (“AHC”).

Typically, the alkyl chain is supplied in the form of an alcohol, although other active hydrogen compounds (“AHC”s) are known, such as sulfhydryl, amino- or carboxylic acid groups. The AHC is then reacted with ethylene and/or propylene oxide, preferably ethylene oxide. The method of reacting alkylene oxides with poly AHCs is well-known to those skilled in the art. The method of making the ethoxylated derivatives of necessity produces a range of degrees of ethoxylation, ranging from zero (free AHC) to the tens of ethylene oxide units per AHC starting unit. This can be advantageous, but a narrower product distribution is better for some applications. These surfactants are characterized, by among other things, the balance between the hydrophilic (water-loving) and hydrophobic (water-fearing) portions of the molecule, known as the HLB. For the instant invention, nonionic surfactants having a HLB of between about 9 to about 14 is preferred, except for the diethanolamide portion, if present (see below).

The resultant reaction product is called an alcohol ethoxylate when starting with an aliphatic alcohol and reacting it with ethylene oxide, and when the carbon chain is linear, a linear alcohol ethoxylate (LAE). Another group of nonionic surfactants that can find utility in the instant invention, but which are not environmentally-preferred are the alkylphenol alkoxylates, more generally alkylphenol ethoxylates (“APEs”). These are exemplified by nonylphenol and octylphenol ethoxylates, the useful range of ethoxylation being from about 6 to about 20. The preferred embodiment of the nonionic portion of the cleaner is a LAE. In a most-preferred embodiment, the LAE has an average numbers of ethylene oxide per carbon chain from about 6 to about 10. Such products are exemplified by TOMADOL® surfactants by Air Products.

The LAE must be present in an efficacious amount, typically from about 0.1 to about 10 percent by weight, preferably from about 1 to about 3 percent by weight. \

Another class of nonionic surfactants that find utility in the instant invention, in combination with other co-surfactants are diethanolamide surfactants. These are made from either a triglyceride or a fatty acid or a fatty acid methyl ester and an excess of diethanolamine. Examples of diethanolamides that find utility in the present invention include but are not limited to coconut, tall oil fatty acid, soybean oil fatty acid, and oleic diethanolamides. Typically, there is an excess of diethanolamine compared to the minimum required to make the diethanolamide, the extra having the purpose to drive the reaction to completion, leading to about a 6-30% concentration of diethanolamine in the final diethanolamide. If present, the diethanolamide is preferably in the range of 0.1-5% by weight, most preferably in the range of 1-3%.

Nonionic surfactants by themselves have limitations in cleaning compositions that often necessitate the addition of co-surfactants. For example, in the presence of salts frequently used to enhance the formulations' cleaning power, the nonionic surfactant may become insoluble above a certain temperature, called the cloud point. As the salt concentration goes up, typically the cloud point of the nonionic surfactant goes down. At the concentration of salts in many alkaline cleaning compositions, the cloud point may be below the maximum storage temperature or even below room temperature, leading to phase instability, resulting in a non-homogeneous product. This is unacceptable to customers.

One typical method of preventing this situation is to add co-surfactants that may not be as strong at cleaning as the nonionic surfactant, but whose presence raises the cloud point of the mixture to above that of the maximum storage temperature. Thus, product homogeneity is assured. A common class of surfactants utilized for this purpose is the phosphate esters of nonionic surfactants. These surfactants are made using methods known to those skilled in the art, and typically have a molar ratio of nonionic to phosphorous of about 1 to about 2, although polyphosphate esters are also frequently used. These coupling agents are made as free acids, and often sold that way, although sometimes the sodium or potassium salts are made prior to offering them for sale.

A preferred embodiment of this class of coupling agent is the ester of a LAE and phosphoric or polyphosphoric acids. A most-preferred embodiment is the ester of a LAE and phosphoric acid, with a mixture of phosphate esters with the number of LAE's to phosphoric acid being from about 1 to about 2. Another most-preferred embodiment is a phosphate ester utilizing a LAE having about 12 to about 18 carbons in the non-polar portion of the LAE and an average degree of ethoxylation from about 6 to about 10. The exact quantity of phosphate ester required is dependent on formulation parameters, but typically ranges from about 0.1 to about 10% by weight.

Other coupling agents that find utility in the instant invention are acids and/or salts of alkyl-aryl sulfonic acids, exemplified by sodium xylene sulfonate, sodium cumene sulfonate, sodium alkylnaphthalene sulfonate and related compounds. These are classic coupling agents. The exact quantity of sulfonate required is dependent on formulation parameters, but typically ranges from about 0.1 to about 10% by weight.

Other coupling agents are known to those skilled in the art. It is not uncommon to mix coupling agents in the same formulation. The coupling agents must be added in an amount sufficient to adjust the cloudpoint of the mixture to above the maximum storage temperature. The exact amount will depend on the formulation details, but typical amounts of coupling agents range from about 0.1 to about 10 percent by weight of the whole formulation (on a coupling agent active ingredient basis), if a coupling agent is required. Most preferably, the coupling agents will be from about 1 to about 5 percent by weight of the whole.

To adequately clean rubber, it is common to add a solvent or solvents to the cleaning composition. Solvents that surprisingly find utility in the instant invention include alkyl esters, alkyl lactates, acetals which are dialkoxymethanes, benzyl alcohol, tetrahydrofurfuryl alcohol, and terpene alcohols such as pine oil, largely terpineol. The dialkoxymethanes that find utility are methyl, ethyl, propyl, isopropyl, butyl, pentyl, hexyl, 2-ethylhexyl and/or mixed-length dialkoxymethane solvents. The alkyl esters and/or lactates are potentially partially bio-derived, but will not survive in the alkaline cleaners that are typically used to clean runways. Therefore, they are not preferred. Other potentially at least partially bio-derived solvents include furfuryl alcohol, tetrahydrofurfuryl alcohol, and terpene alcohols. These partially or fully bio-derived solvents are typically added into the formulation from about 0.1 to about 10 percent, preferably from about 1 to about 5 percent, and most preferably from about 1 to about 4 percent by weight.

Other solvents that can find utility in addition to the preferred dialkoxymethane and/or benzyl alcohol include glycol ethers. Glycol ethers are compounds that include ethylene glycol, propylene glycol, diethylene glycol dipropylene glycol, triethylene glycol or tripropylene glycol, etherified at one end with an alkyl group, typically methyl, ethyl, propyl or butyl, although other alkyl groups also find utility in the instant invention. Glycol ethers of the “E” series, i.e. ethers of ethylene glycol or higher homologues, are increasingly being frowned upon due to toxicity and environmental concerns, and so are not preferred. Propylene-glycol based glycol ethers are therefore a preferred embodiment. Most-preferred are the methyl, ethyl, propyl or butyl ethers of propylene or dipropylene glycol. Glycol ethers are typically added and find utility in the instant invention at a concentration from about 0.1 to about 10% by weight of the whole formulation.

Although the glycol ethers can be powerful penetrating solvents, other solvents are useful as well, either by themselves or in combination with other solvents, such as the glycol ethers. An example of a solvent class which also find utility in the instant invention is the terpene hydrocarbons. Examples of terpene hydrocarbons that find utility in the instant invention include d-limonene and dipentene, from orange and pine tree processing, respectively. Dipentenes are complex mixtures which vary from location to location and also with the time of year. Terpenes are not a preferred embodiment, due to their seasonal and/or cyclical availability. Terpenes are typically added and find utility in the instant invention at a concentration from about 0.1 to about 10% by weight of the whole formulation.

Also, although not preferred embodiments, alkyl esters and terpene alcohols potentially find utility in the instant invention. Alkyl esters, such as the methyl ester prepared by transesterification of a vegetable oil such as soybean oil, or an animal-derived fat or oil such as chicken fat, or alternatively alkyl lactates, have useful solvent properties, but are unstable in alkaline solution, and so would limit the amount and kind of builders present. They are therefore not a preferred embodiment. If present, they too are typically added and find utility in the instant invention at a concentration from about 0.1 to about 10% by weight of the whole formulation

Terpene alcohols, such as pine oil, have strong, often objectionable odors, and their solvency for non-polar substrates such as runway rubber is limited. Therefore they also are not a preferred embodiment. However, if present, they too are typically added and find utility in the instant invention at a concentration from about 0.1 to about 10% by weight of the whole formulation.

The total solvent component or mixture of components of the instant invention should be present from about 0.1 to about 10 percent by weight. In a preferred embodiment, the solvent is present from about 1 to about 4 percent by weight. One skilled in the art can easily see that careful experimentation can lead to an optimum formulation. Other solvents may also find utility in the instant invention. The nature and optimal concentrations of these are known to those in the art. The discussion above is for purposes of example, not intended to be limiting.

As a general rule, builders are necessary for a good runway cleaner. Commonly used builders include lithium, sodium or potassium hydroxides, carbonates, bicarbonates, silicates, borates, phosphates, phosphonates or oligo- or polyphosphates. The sodium or potassium salts are preferred, although in certain situations lithium and perhaps even cesium salts find utility. In actual practice combinations of these builder classes are not uncommon. The builder or builder combination must be present in the range from about 0.1 to about 10 percent by weight of the formulation. In a preferred embodiment, the builder or builders are present from about 3 to about 8 percent by weight on an active ingredient basis.

Many builders react with calcium or magnesium to cause precipitates to form, removing them from the cleaning zone. Therefore, it is common to include chelating agents to ameliorate this “hardness” in the wash water. Many such chelating agents are known to those skilled in the art. Examples include but are not limited to ethylenediamine tetra acetic acid, ethylenediamene triacetic acid, nitrilo-tris-acetic acid, glucuronic acid, gluconic acid, erythorbic acid, and citric acid or the sodium, potassium, lithium or cesium salts or mixtures and combinations of these. The hardness ameliorating agent should be present from about 0.1 to about 10 percent by weight of the whole, preferably from about 0.1 to about 1 percent of the whole.

Optional additional surfactants may be added for optimization of the formulation. Examples of such additional surfactants come from the classes of cationic, anionic, amphoteric or amine oxide surfactants.

Examples of other nonionic surfactants that find utility in the instant invention include but are not limited to block copolymers of ethylene and propylene oxide, alkyl glucosides and alkyl glycosides.

Examples of anionic surfactants that find utility in the instant invention include, but are not limited to the acid or sodium or potassium salts of alkylbenzene sulfonic acid, tall oil fatty acid, carboxylated nonionics, alkyldiphenyloxide disulfonic acids, and/or mixtures and combinations of these. It is to be understood that the instant invention is an alkaline cleaner, so alkalinity must be added to compensate for any acids included in the formulation.

Examples of cationic surfactants which find utility in the instant invention are somewhat limited in their structure and/or useful concentration by the negative interaction of cationic surfactants and anionic surfactants or coupling agents. Examples of cationic surfactants which find utility in the instant invention include but are not limited to the cationic surfactants of U.S. Pat. No. 4,239,631 to Brown, included herein by reference and alkyldimethylhydroxyl ammonium chlorides.

Examples of zwitterionic surfactants which find utility in the instant invention include but are not limited to betaines, glycinates, amphopropionates and amphodipropionates, and mixtures and combinations of these.

The optional surfactant or surfactant combination should be added from about 0.1 to about 10 percent active by weight of the whole.

### Example

The following formulation was made using either (A), a combination solvent package of equal parts d-limonene and dipropylene glycol methyl ether (DPM), (B) a combination solvent package of equal parts d-limonene and dibutoxymethane (DBM), or (C) a combination solvent package of equal parts d-limonene and benzyl alcohol (BzOH).

| Material | Percent by weight |
|---|---|
| Na4-EDTA, 40% solution | 0.1% |
| Potassium Hydroxide 45% | 13.0% |
| sodium silicate 2.0 ratio | 4.5% |
| trisodium phosphate crystal | 2.2% |
| Nonionic surfactant HLB 13 | 2.0% |
| Nonionic phosphate ester | 5.0% |
| Solvent | 2.0% |
| d-limonene | 2.0% |
| water | QS 100% |

These three formulations were tested on the centerline on an asphalt runway that had a buildup of rubber in the spot tested. A spot was marked out for each, each spot being identical in length to the others. Approximately 1.0 mL of each cleaner was spread out on the spot, producing a wetted area. After 6 minutes, the spots were scrubbed using a wet, clipped vehicle wash brush with rollers on it to allow equal pressure on each spot, using 10 back-and-forth cycles on each spot. The spots were then wiped up thoroughly with damp paper towels, and then gently cleaned of removable residue four times using a wet paper towel. The spots were then allowed to dry and photographed as a group. An otherwise identical spot was cleaned using only water as a comparison.

The digital image of the cleaned surface was converted to 16-bit black and white picture using Microsoft Paint. The image was then analyzed using the “Image J” freeware, available from the National Institutes of Health website. An identical uncleaned spot was similarly analyzed. The comparison analysis consisted of dividing the integrated “brightness” score of each area by the brightness score of the uncleaned spot of equal area. Identical areas were utilized for each spot. In this manner, a reasonably objective measure of the effectiveness of each cleaner was obtained. The results of two trials are below.

| Sample | Solvent | % White | Deviation | Rank |
|---|---|---|---|---|
| A | DPM | 48% | 5.6% | 2 |
| B | DBM | 57% | 2.7% | 1 |
| C | BzOH | 56% | 0.2% | 1 |
| Blank | Water | 5.4% | 1.8% | 3 |

As can be seen, the Environmentally-preferred formulations B and C actually outperformed the traditional formulation containing DPM, and all three strongly outperformed the water-only blank. This shows that the runway cleaners utilizing these novel solvents were efficacious.

I claim:

1. A cleaning composition comprising:
A. A nonionic surfactant containing at least one carbon chain of length 4-20 and at least one oxyethylene or oxypropylene group, said nonionic surfactant being from about 0.1 to about 10 percent by weight of the formulation as a whole,
B. At least one coupling agent selected from the group consisting of: a phosphate ester of a nonionic surfactant containing at least one carbon chain of length 4-20 and at least one oxyethylene or oxypropylene group, the molecular ratio of nonionic surfactant to phosphorous being from about 0.1 to about 2; alkylaromatic sulfonic acids and/or their salts, such as sodium xylene sulfonate; said coupling agent being from about 0.1 to about 10 percent by weight of the whole,
C. At least one solvent selected from the group containing benzyl alcohol, acetals which are di(alkoxy) methanes, alkyl esters of lactic acid, and optionally at least one solvent selected from the group consisting of glycol ether solvents and solvent terpenes, alkyl esters, terpene alcohols; said solvent or solvent combination being from about 0.1 to about 10 percent by weight of the whole,
D. At least one builder selected from the group containing hydroxides, silicates, phosphates, oligophosphates, polyphosphates, alkyl phosphonic acids, borates, carbonates or bicarbonates of sodium, potassium, lithium or cesium, said builder or builder combination being from about 0.1 to about 15 percent by weight (on an active ingredient basis) of the whole,
E. Optional additional surfactants selected from the group containing cationic, anionic, nonionic, amphoteric, amine oxide or diethanolamide surfactants, said optional surfactant or surfactant combination being from about 0.1 to about 10 percent by weight of the whole,
F. Optionally a hardness ameliorating agent selected from the group containing ethylenediamine tetra acetic acid, ethylenediamene triacetic acid, nitrilo-tris-acetic acid, glucuronic acid, gluconic acid, erythorbic acid, and citric acid and/or the sodium, potassium, lithium or cesium salts of these or mixtures and combinations of these, said hardness ameliorating agent being from about 0.1 to about 10 percent by weight of the whole, and
G. The balance being water.

2. A method of cleaning rubber off of rubber-soiled runways that does utilizes a cleaning composition with environmentally-friendly solvents, comprising:
A. exposing a soiled runway surface to a cleaning composition by spraying, dumping or otherwise wetting the surface with the cleaner,
B. scrubbing for an efficacious amount of time using steel- and/or nylon-bristled brooms, followed by
C. rinsing using an appropriate amount of water while scrubbing, or alternatively after an efficacious amount of time of scrubbing, utilizing pressurized water to remove any detritus, or alternatively utilizing pressurized water to remove rubber and any detritus after exposing the runway to the cleaner without scrubbing, said cleaning composition comprising:
1. A nonionic surfactant containing at least one carbon chain of length 4-20 and at least one oxyethylene or oxypropylene group, said nonionic surfactant being from about 0.1 to about 10 percent by weight of the formulation as a whole,
2. At least one coupling agent selected from the group consisting of: a phosphate ester of a nonionic surfactant containing at least one carbon chain of length 4-20 and at least one oxyethylene or oxypropylene group, the molecular ratio of nonionic surfactant to phosphorous being from about 0.1 to about 2; alkylaromatic sulfonic acids and/or their salts, such as sodium xylene sulfonate; said coupling agent being from about 0.1 to about 10 percent by weight of the whole,
3. At least one solvent selected from the group containing benzyl alcohol, an acetal which is a di(alkoxy) methane, alkyl esters of lactic acid, and optionally one solvent selected from the group consisting of glycol ether solvents and solvent terpenes, alkyl esters, terpene alcohols; said solvent or solvent combination being from about 0.1 to about 10 percent by weight of the whole,
4. At least one builder selected from the group containing hydroxides, silicates, phosphates, oligophosphates, polyphosphates, alkyl phosphonic acids, borates, carbonates or bicarbonates of sodium, potassium, lithium or cesium, said builder or builder combination being from about 0.1 to about 15 percent by weight (on an active ingredient basis) of the whole,
5. Optional additional surfactants selected from the group containing cationic, anionic, nonionic, amphoteric, amine oxide or diethanolamide surfactants, said optional surfactant or surfactant combination being from about 0.1 to about 10 percent by weight of the whole,
6. Optionally a hardness ameliorating agent selected from the group containing ethylenediamine tetra acetic acid, ethylenediamene triacetic acid, nitrilo-tris-acetic acid, glucuronic acid, gluconic acid, erythorbic acid, and citric acid and/or the sodium, potassium, lithium or cesium salts of these or mixtures and combinations of these, said hardness ameliorating agent being from about 0.1 to about 10 percent by weight of the whole, and
7. The balance being water.
